(19) United States
(12) Patent Application Publication
(10) Pub. No.: US 2003/0044266 A1
(43) Pub. Date: Mar. 6, 2003

(54) Power rear door interface for a vehicle having a rear entry folding ramp

(76) Inventors: Sieto Vandillen, Battle Creek, MI (US); Robert Wentworth, Battle Creek, MI (US); Todd J. Blandford, Battle Creek, MI (US)

Correspondence Address: FLYNN, THIEL, BOUTELL & TANIS, P.C., 2026 Rambling Road, Kalamazoo, MI, 49008-1699, US

(21) Appl. No.: 09/945,023

(22) Filed: Aug. 31, 2001

(51) Int. Cl. A61G 3/08

(52) U.S. Cl. 414/537

(57) ABSTRACT

A vehicle, such as a mini-van, is modified to include a vehicle kneel pump system and a ramp pump system. The kneel pump system lowers the rear end of the vehicle. The ramp pump system controls a rearwardly folding ramp to enable entrance and egress from the vehicle of a wheelchair bound person. A loading control system integrated into the vehicle includes a loading controller which controls the ramp pump system and the vehicle kneel pump system. In response to pushing a button of a remote controller, a powered door operating system controls the door. In response to signals received from the door operating system, the loading controller controls the kneel pump system and the ramp.

### FIELD OF THE INVENTION

This invention relates to a vehicle modified to enable entrance and egress of a wheelchair bound person, or a person using a motorized one-seat scooter-type vehicle or the like. Entrance and egress is through a rear door utilized in combination with a powered folding ramp and a kneel pump system. The kneel pump system lowers a rear end of the vehicle to enable the folding ramp to open and contact the ground surface for loading a person. The kneel pump system raises the rear end body of the vehicle and the folding ramp closes to enable normal operation of the vehicle. Such modified vehicles typically include a driver transfer device for transferring a user to the driver's seat.

### BACKGROUND OF THE INVENTION

The use of lifts, ramps and other devices for entrance and exit of personal transportation devices, such as powered wheelchairs or scooter-type vehicles like the AMIGO™ motorized cart, from vehicles is well known in the art. Many prior art systems, however, require a side entrance to the vehicle. Handicapped parking spaces in parking lots generally afford sufficient room to permit a wheelchair user to enter the vehicle through a side lift or ramp device. However, the use of such devices with a vehicle, such as a mini-van, requires the driver to find a handicapped parking space. Sometimes though, handicapped parking spaces are not available. In other instances, a second vehicle may park very close to and the adjacent a side of the vehicle. In this situation, due to the length of the ramp, the user is prevented from re-entering the vehicle. This can occur in a handicapped parking space, as well as in other parking spaces.

A more useful modified vehicle includes a powered folding ramp extending outwardly from a rear entrance of the vehicle and a powered rear door. Such an arrangement enables a user to park the vehicle, such as a mini-van, in a non-handicapped parking place in a parking lot and still exit through the rear entrance, even if both sides of the vehicle are effectively blocked.

Prior Art FIGS. 1 and 2 show such a modified vehicle 4 providing rear entrance and egress for a user with a personal transportation device. FIG. 1 shows an upwardly swinging liftgate as an open rear door 30 and a folding ramp 28.

The FIG. 2 interface circuit includes a vent switch 6 connected by vent window control lines 8, 10 to a vent window motor 12. The vent switch 6 controls the position of a vent window (not shown) by controlling the vent window motor 12. The vehicle also has a standard vehicle ignition switch 14 and a battery 16.

The vehicle 4 is modified to include a loading/unloading control system 20 enabling a person using a personal transportation device to enter and exit the vehicle.

The loading control system 20 includes a loading controller 22. The loading controller 22 includes analog RC-circuits and the like for controlling relays. The controller 22 provides output signals to a kneel pump system 24. The controller 22 controls relays of the kneel pump system 24 to power an electric powered hydraulic pump. The hydraulic pump moves a rear end body of the vehicle 4 between a lowered kneeling position and a raised driving position.

The controller 22 also controls relays of a ramp and rear door pump system 26. The ramp and rear door pump system 26 operates an electric powered hydraulic pump to hydraulically move the folding ramp 28 and the door 30, as shown in FIG. 1. The combination of lowering or kneeling the rear end body and deploying the ramp 28 enables the extended end of the ramp to touch the ground outwardly from the rear end of the vehicle Thus rear access/egress is provided for a person using a transportation device.

The loading controller 22 controls a rear door release solenoid 32 to open a latch of the door 30. The release solenoid 32 is controlled by a low current signal on a rear door holding line 34 or a high current pull signal on a rear door pull line 36. The controller 22 sends the appropriate signals to automatically unlatch the door 30 in response to a power signal. The controller 22 sends a momentary door-pull signal on line 36 to open the rear door latch. The controller 22 sends a hold signal on line 34 to hold the rear door latch in a released position.

The controller 22 connects through control lines 69a-69d to the window control lines 8, 10. Thus, the controller 22 is connected to the vent switch 6 and selectively operates the vent window motor 12 to open and close the vent window. The controller 22 includes timing circuits to provide timed control of the vent window motor 12.

A portable remote controller 40 includes an opening push button 42 and a closing push button 44. The remote controller 40 transmits radio frequency signals to a two-channel remote control receiver 46. Each channel corresponds to a push button. The receiver 46 has a ground line 48 to ground the receiver 46 and a power line 50 to receive operating power. The receiver 46 includes an opening signal line 52 for outputting a ramp opening signal to the controller 22.

The receiver 46 also includes a closing signal line 54 for outputting a closing signal to the controller 22. In response to the closing signal, the controller 22 closes the ramp 28, closes the door 30 and moves the rear end of the vehicle to a driving position.

The control system 20 includes an ignition switch status line 56 having a fuse 58 that connects the ignition switch 14 to the controller 22. The fuse 58 protects the controller 22 from a current spike. An internal diode (not shown) in the controller 22 also prevents leakage of current into the vehicle electrical system.

The control system 20 also includes a manual momentary two-way rear door control switch 60. The control switch 60 connects with the controller 22 through a manual opening signal line 62 and a manual closing signal line 66. A power receiving line 64 provides power to the control switch 60. In a first actuated position, the control switch 60 signals the controller 22 to open the door 30. In a second actuated position, the control switch 60 signals the controller 22 to close the door 30.

The opening signal line 62 is connected to the same input of the controller 22 as the opening signal line 52 of the receiver 46. Thus either the remote controller 40 or the manual control switch 60 opens the rear door. The closing signal line 66 is connected to the same input of the controller 22 as the closing signal line 54 of the receiver 46.

Main fuse 67 and fuse block 68 supply power from the battery 16 to the controller 22. The fuse and fuse block protect the battery 16 from power loss due to a short circuits or the like, in the controller 22

As shown in FIG. 1, a rear door hydraulic drive 70, which is an element of the ramp and rear door pump system 26 moves the door 30 to an upright open position. The ramp 28 is secured to a lowered floor 71 installed in the vehicle. The lowered floor 71, combined with the ramp 28, provides an appropriate angle of ascent for a wheelchair. The ramp and rear door pump system 26 also includes a ramp spring 72 biased to close the ramp 28 and a ramp hydraulic drive 74 for opening and closing the ramp 28. The gas shock absorbers 76 are biased to prevent sudden closing of the rear door. The ramp pump system 26 uses hydraulic pressure to deploy or store the ramp 28.

The kneel pump system 24 uses hydraulic pressure to raise and lower the rear end body of the vehicle. The kneel pump system 24 includes an electric pump motor (not shown) that provides hydraulic pressure to an apparatus joined to the rear axle and the vehicle body. Through the apparatus, the pressure lowers the rear end of the vehicle. In the driving position, the apparatus preferably releases the force connection of the apparatus between the rear end body and the vehicle axle. Then only a standard suspension supports the rear end body relative to the vehicle axis, as if no apparatus were mounted thereto.

Operation of the control system 20 in FIG. 2 is as follows. To open the door 30, a user depresses the opening push button 42 of the remote controller 40, which sends a signal. The receiver 46 receives the signal. The receiver 46 then sends an opening signal to the controller 22 so long as the push button 42 remains depressed. In response to the opening signal, the controller 22 sends a momentary power signal to the solenoid 32, which opens the rear door latch. The momentary signal prevents damage to the solenoid 32. The controller 22 then sends a current signal to the solenoid 32 to maintain the door latch in the open position. When the push button 42 is released, all signals to the release solenoid 32 are removed. Consequently, the solenoid 32 releases the rear door latch.

In response to depressing the push button 42, the controller 22 also signals the kneel pump system 24 to lower the rear end of the vehicle 4. The controller 22 opens the door 30 and deploys the ramp 28. Thus the deployed arrangement shown in FIG. 1 is achieved.

In the above-described opening of the ramp and rear door system 26, the user must maintain the opening push button 42 in an actuated position to allow complete opening of the door 30 and ramp 28. Release of the opening push button 42 stops movement of the door and ramp.

The closing push button 44 operates in the same manner as the opening push button 42. Closing the push button 44 causes controller 40 to transmit a signal to the receiver 46. A second channel of the receiver 46 receives the signal. The receiver then outputs a closing signal to the controller 22. In response to the closing signal, the controller 22 moves the ramp 28 into an upright stored position and closes the door 30. In response to the closing signal, the controller 22 also raises the rear end of the vehicle.

In closing the ramp 28, the ramp spring 72, shown in FIG. 1, provides extra force to close the ramp quickly compared to the hydraulic drive 70 closing the door 30. In addition, the gas shock absorbers 76 resist closing of the door 30. Thus, a collision between the ramp 28 and the door 30 is avoided.

Further, with respect to closing the door 30 of the vehicle, the vehicle 4 is essentially airtight. Accordingly, the controller 22 opens the vent window (not shown) during closing and latching of the door 30. Thus, there is no air resistance to closing the door 30. The controller 22 then closes the vent window after the door is shut.

In operation, the controller 22 receives a status signal from the ignition switch 14 that the motor is running or the key is in the accessory on position (on). In response to the status signal, the controller 22 cuts power to the control switch 60 and the receiver 46. Cutting power prevents erroneous operation of the ramp 28 and the door 30. In response to the status signal, the controller 22 also operates the kneel pump system 24 for about three seconds to ensure that the vehicle rear end is in the raised driving position. The controller 22 then shuts off the hydraulic pump systems 24, 26.

Thus, this control system 20 modifies an existing vehicle having a manually actuated rear door 30. The integrated system opens and closes the rear door, lowers and raises the rear end of the vehicle, and deploys or stores the ramp 28 in the vehicle.

Another known system combines the basic features of the system described in FIGS. 1 and 2 with a vehicle having a remote controller for a manufacturer installed powered rear door. The remote controller for the door has a one-touch push button. Instead of a rear door pump system as in FIGS. 1 and 2, an electric motor opens and closes the rear door. Besides the rear door, the remote controller has separate buttons to control locking/unlocking of the vehicle doors and control of an alarm device. The known system also includes an additional remote controller. The additional remote controller, remote control receiver and other circuitry are similar to that shown in prior art FIG. 2. The additional devices separately control the kneel pump system and the ramp pump system.

This known system does not connect to the vent switch 6, the vent window motor 12, or the rear door release solenoid 32.

This known system has the disadvantage of first and second remote controllers that must be stored and utilized by a user.

Further, the known system has the disadvantage of one remote controller having one-touch push button control while the other controller has two buttons which must be properly selected and continuously pushed for a proper time in order to operate the kneel down system and ramp system. Operating the remote controllers in the wrong order, or not pressing down one of the push buttons for the appropriate amount of time could damage the rear door or folding ramp.

Further, this known system includes the cost, as well as the inconvenience, of first and second remote controllers and first and second receivers. The first and second remote controllers include transmitters and require a considerable amount of pocket or handbag space. Thus, there is an unmet need to provide a convenient and simplified system integrating the kneel pump system 24 and the ramp pump system 26 into a vehicle having a powered rear door.

### SUMMARY OF THE INVENTION

The invention provides an interface between a motor vehicle having a powered rear door with a kneel pump system and a ramp pump system The systems lower a folding ramp and vehicle rear end so a wheelchair bound person can enter and exit the vehicle. The interface allows a single rear door remote controller to control the rear door, the ramp system and the kneel pump system Thus, the integrated interface eliminates the need for two separate remote controllers and two separate receivers. Further, there is no longer separate operation of the rear door and the ramp and kneel pump system.

By integrating the kneel pump system and the ramp pump system with the vehicle powered rear door system, timing problems between the door and the ramp are eliminated. Thus, improper use of a door remote controller, in combination with a ramp remote controller, cannot occur. The rear door and the ramp cannot strike each other. Therefore, the likelihood of inadvertent damage to the system is minimized and the overall integrity of the system is improved.

The kneel pump system lowers and raises the rear end of the vehicle to and from a loading position. The ramp installed in the vehicle at the rear end deploys outwardly through the rear door. The ramp pump system moves the ramp between a stowed position within the vehicle and a deployed position with the extended end resting at ground level.

A loading control system includes a loading controller for providing output control signals to the kneel pump system and the ramp pump system. Interfacing the control system to a rear door operating system provides door opening and closing signals to the loading controller.

### BRIEF DESCRIPTION OF THE DRAWINGS

FIG. 1 shows a prior art motor vehicle modified to include a kneel pump system, a powered folding ramp and a powered rear door.

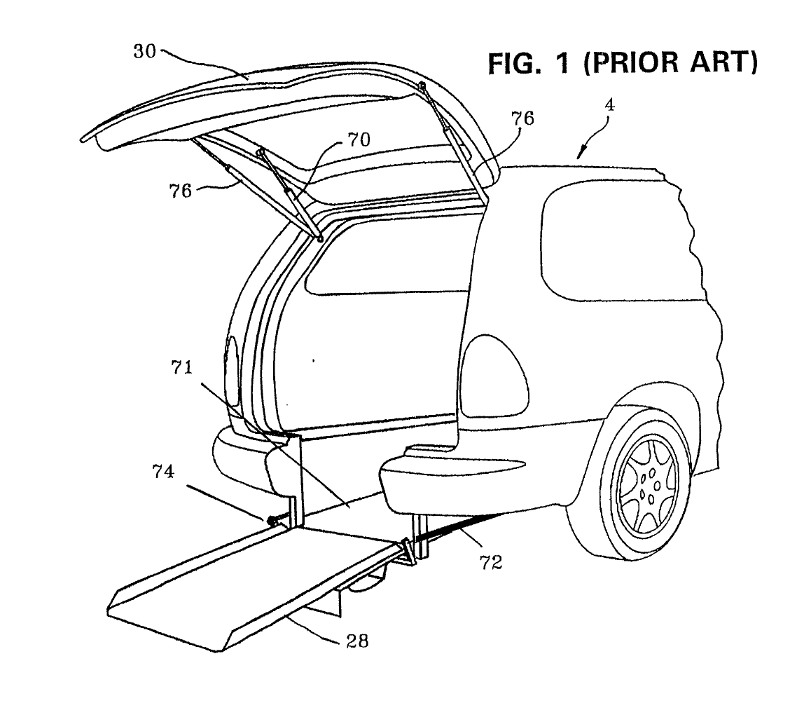

FIG. 2 shows a prior art interface for the vehicle of FIG. 1 including a loading control system connected to components of the motor vehicle.

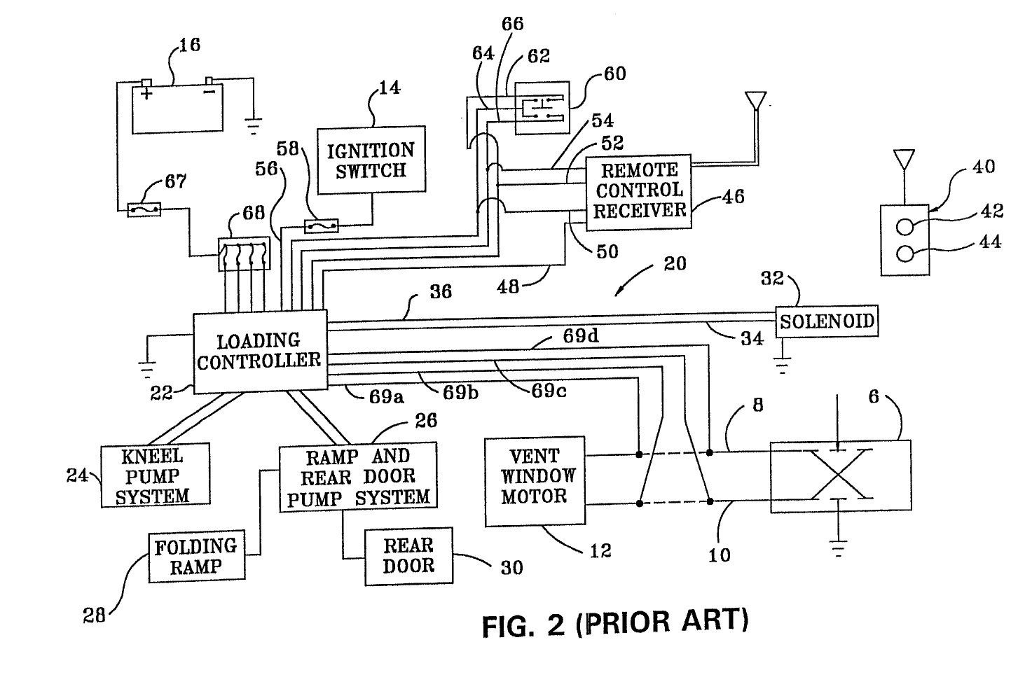

FIG. 3 shows a vehicle of the invention having a powered rear door and including a kneel pump system and a powered folding ramp.

FIG. 4 shows an integrated vehicle interface for the vehicle of FIG. 3 including a loading control system combined with components of a powered rear door operating system.

### DETAILED DESCRIPTION

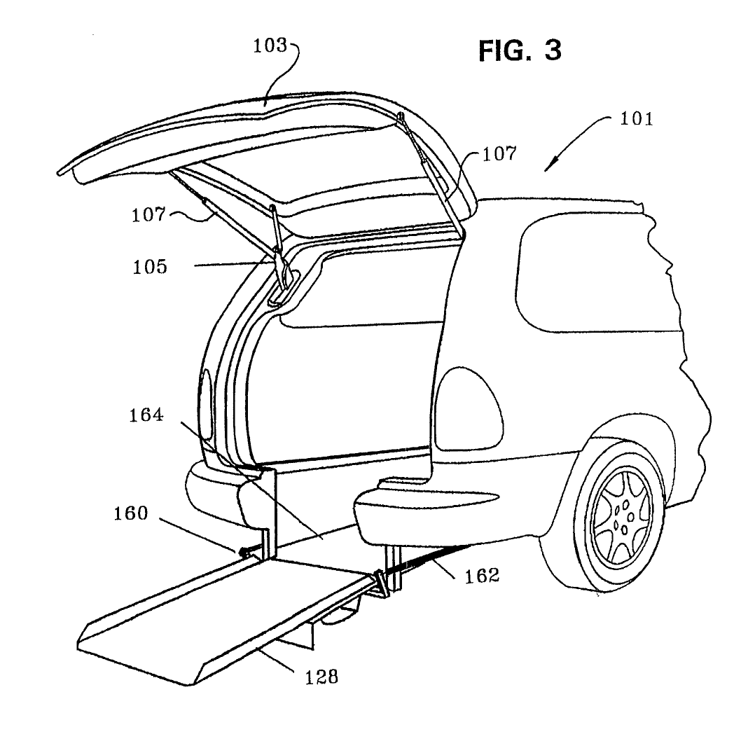

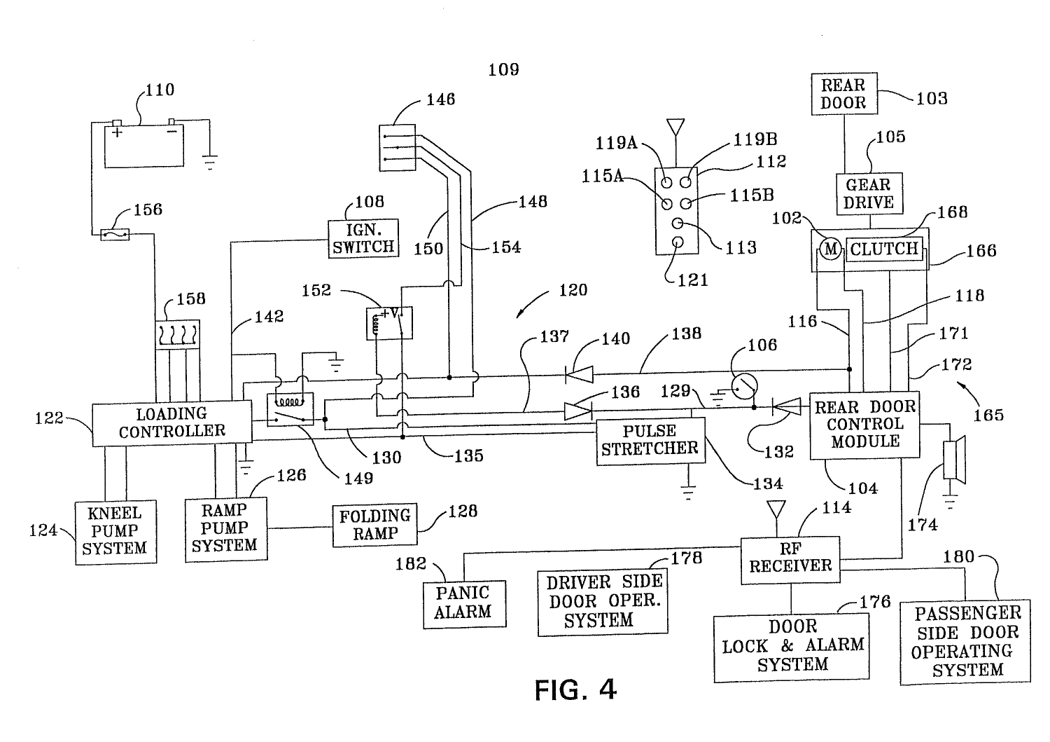

FIG. 3 depicts a vehicle 101 having a vehicle body 109 and a powered rear door 103. The vehicle 101 includes a retractable folding ramp 128 to enable entry and egress. A kneel pump system 124, shown in FIG. 4, kneels the rear end toward ground level. FIG. 4 also shows a loading/unloading control system 120 and a powered rear door operating system 165 for the vehicle 101 of FIG. 3.

As illustrated in FIG. 4, the rear door operating system 165 has a rear door control module 104 and a drive unit 166. The drive unit 166 includes a bi-directional electric rear door motor 102 and a rear door motor clutch 168. The control module 104 selectively applies power, over power lines 116, 118, to the motor 102. Power applied to line 116, a REVERSE signal, rotates the motor 102 in a direction for closing the door 103. Power applied to line 118, a FORWARD signal, rotates the motor in an opposite direction for opening the door 103.

The control module 104 also sends clutch control signals over clutch control lines 171, 172 to the clutch 168. Depending on the control signals, the clutch 168 couples or uncouples the motor 102 to a gear drive 105 (FIG. 4) The motor 102 powers the gear drive 105 to raise and lower the door 103. The gear drive 105 provides a linkage between the motor 102 and the door 103.

The control module 104 connects to a rear door limit switch 106. The limit switch 106 closes to provide a ground voltage (DOOR_OPEN signal) when the door 103 is fully opened. An input of the control module 104 receives the DOOR_OPEN signal. In response to this signal, the control module 104 releases the clutch 168 and stops door opening movement.

Rear door gas shock absorbers 107, shown in FIG. 3, connect to the door 103 and rear door frame. The shock absorbers 107 are biased to resist closing of the door 103.

The loading control system 120 includes a loading controller 122. The controller 122 receives input signals to control the ramp 128 and kneeling of the vehicle 101. The controller 122 includes timing circuits, formed by resistors and capacitors. The timing circuits control relays for powering pump devices for predetermined time periods.

FIG. 4 shows an ignition switch 108 having an ignition switch/ACC output connected by ignition switch status line 142 to an input of the controller 122. The status line 142 provides a status signal indicating that the ignition switch is in the “on” position or the ACC position.

Vehicle battery 110 supplies power through a fuse 156 and a fuse block 158 to the controller 122. The fuse and fuse block protect the battery 110 from a drain of power due to a short circuit or the like in the controller 122.

The vehicle 101 includes a portable remote controller 112 with one-touch push buttons 113, 115A, 115B, 119A, 119B, 121. In response to a push and release of one of the buttons 113, 115A, 115B, 119A, 119B, 121, the remote controller 112 transmits a single radio frequency signal to a receiver 114 for a fixed period of time. Each push button controls the transmitter to output a corresponding unique signal.

The receiver 114 receives the signal from the selected push button The receiver 114 determines which push button 113, 115A, 115B, 119A, 119B, 121 provided the signal. The receiver provides an output to the appropriate selected system or device.

For example, in response to actuation and release of the door lock button 119A, the remote controller 122 transmits a signal to the receiver 114. The receiver 114 provides a lock output signal to the door lock and alarm system 176. The door lock and alarm system 176 powers motors that lock the vehicle doors and arms the vehicle alarm system.

In response to actuation and release of the door unlock button 119B; the remote controller 112 transmits another unique signal to the receiver 114. The receiver 114 provides a separate unlock signal to the door lock and alarm system 176. The door lock and alarm system 176 then powers the same motors to unlock the vehicle doors and disables the vehicle alarm system.

In response to actuation of the driver's side power door button 115A, the remote controller 112 transmits a signal to the receiver 114. The receiver 114 provides a side door actuate signal to the driver side door operating system 178. The operating system 178 opens or closes a side door of the vehicle in response to the actuate signal and the side door position. The door operating system 178 powers a motor that moves the driver side door.

Actuation of the passenger side power door button 115B causes the remote controller 112 to transmit a passenger door actuate signal to the receiver 114. The receiver 114 provides a signal to the passenger side door operating system 180. As with the drive side door operating system 178, the passenger side door operating system opens or closes a passenger side door.

In response to actuation of the panic button 121, the remote controller 112 transmits yet another different signal. The receiver 114 receives the signal and provides a control signal to a panic alarm device 182. The alarm device 182 immediately triggers the vehicle alarm system.

In response to touch and release of the rear door push button 113, the remote controller 112 transmits yet another signal to the receiver 114. The receiver 114 receives the signal from the controller 112 and outputs a DOOR_ACTUATE signal to the control module 104.

In response to the DOOR_ACTUATE signal, the control module changes the position of the door 103. If the door 103 is open when the DOOR_ACTUATE signal is received, the control module 104 provides a REVERSE power signal to the motor 102. After a time delay, the control module 104 provides a door closing signal to the clutch 168. The clutch engages the motor 102 with the gear drive 105 to close the door. If the door 103 is closed when the control module 104 receives the DOOR_ACTUATE signal, the control module 104 provides a FORWARD power signal to the motor 102. The control module 104 also provides a door opening signal to the clutch 168. The clutch 168 couples the powered motor 102 to the gear drive 105 to open the door 103.

Turning now to other systems of the modified vehicle 101, the loading control system 120 provides various input signals to the controller 122. In response to a RAMP_CLOSE signal, the controller 122 controls the kneel pump system 124 to hydraulically raise the rear end of the vehicle 101 to a driving position. In response to a DOOR_OPEN signal, the controller 122 controls the kneel pump system 124 to lower the rear end of the vehicle 101 to a loading position shown in FIG. 3.

The kneel pump system 124 includes an electric pump motor (not shown) that provides hydraulic pressure to a hook apparatus or other element to move the rear end of the vehicle 101. The hook apparatus is secured to the axle and the vehicle body. To reach the kneeling position, the hook apparatus moves the vehicle body relative to the rear wheel axis. In the driving position, the hook apparatus releases the force connection of the apparatus between the rear end body and the vehicle axle. Then only a standard suspension supports the rear end body relative to the vehicle axis, as if no apparatus were mounted thereto. Thus the kneel pump system 124 moves the rear end of the vehicle 101 between a loading position close to ground level and a normal driving position.

The controller 122 also controls a ramp pump system 126. The ramp pump system 126 hydraulically moves the ramp 128 between a deployed position and a substantially vertical upright stowed position. In the deployed position shown in FIG. 3, the ramp 128 contacts the ground at ground level rearwardly of the vehicle 101.

The ramp pump system 126 includes an electrically powered hydraulic pump motor. The pump motor controls hydraulic pressure applied to a ramp hydraulic driver 160. The hydraulic driver 160 moves the ramp 128 between the stowed position and the deployed position extending outwardly from vehicle.

As shown in FIG. 3, a ramp spring 162 connects to the ramp 128 and the rear end of the vehicle body 109. The ramp spring 162 provides extra force to assist in closing of the ramp 128.

A lowered interior floor 164 is formed in or installed in at least part of a rear end section of the vehicle. The lowered floor assists in providing a desired angle of inclination for the deployed ramp 128. Thus, a wheelchair or other personal transportation device requires less force to enter the vehicle 101. The lowered interior floor 164 is closer to ground level adjacent the rear end of the vehicle 101 than the interior floor adjacent the front end of the vehicle.

In the control system 120 of FIG. 4, a rear door limit switch signal line 129 interfaces the control system 120 and the door operating system 165. The signal line 129 connects to the output pin of the limit switch 106 and to a pulse stretcher 134. Thus, signal line 129 supplies the output signal (DOOR_OPEN signal) from the limit switch 106 to the pulse stretcher 134. The pulse stretcher 134 detects the falling edge of the output signal from the limit switch 106 closing caused by a select amount of opening of the door 103. The pulse stretcher 134 then outputs a single fixed period pulse signal via a ramp opening signal line 130 to the controller 122. This signal is a positive pulse that continues for a predetermined length of time, preferably about 7 to 10 seconds. Thus, the pulse stretcher 134 acts as a timer providing a signal for a predetermined time to the controller 122.

A power supply line 135 provides operating power to the pulse stretcher 134.

A line protection diode 132 is positioned between the signal line 129 and the input pin of the control module 104. The diode 132 is also positioned between the input pin of the control module 104 and the limit switch 106. The line protection diode ensures that current from the pulse stretcher 134 or any other part of the control system 120 does not affect the control module 104 or other components of the door operating system 165.

A closing input signal line 138 extends between the power line 116 and loading controller 122. Signal line 138 carries a power signal applied to the motor 102 over power line 116 to an input of the controller 122. The disengaged clutch 168 prevents immediate driving of the door 103 by the motor 102. Thus, the power signal applied to the electric motor 102 does not immediately close the door 103. The power signal (REVERSE signal) acts as the RAMP_CLOSE signal provided to the controller 122 on signal line 138.

A protection diode 140 is provided with the closing input signal line 138. The protection diode prevents voltage from the control system 120 affecting power to the motor 102.

The control system 120 includes a single pole double throw momentary center-off manual switch 146. Switch 146 is located at or near the dashboard for actuation by a user. The switch 146 is biased at a non-contacting open position. In a first depressed position, the switch 146 sends a manual opening signal along a manual opening signal line 148 to the controller 122. The manual opening signal line 148 connects to the same input of the controller 122 as the ramp opening signal line 130. In a second position, the switch 146 sends a manual closing signal along a manual closing signal line 150 to the controller 122. The closing signal line 150 connects to the same input of the controller 122 as the closing input signal line 138 which carries the RAMP_CLOSE signal.

A power line 154 provides power to a main switch contact of the manual switch 146.

A switch defeating relay 152 series connects between the power line 154 for the manual switch 146 and the power supply line 135. Relay control line 137 connects a coil of the relay 152 to the input signal line 129 through protection diode 136. When the door 103 is less than fully opened, the voltage at the pin of the limit switch 106 floats. The voltage drop across the coil of the relay 152 is not large enough to provide sufficient current through the coil to close the relay. When the door 103 opens, the limit switch 106 outputs a ground voltage or signal. The ground voltage lowers or drops the voltage floating on line 137. The voltage drop causes increased current flow through the relay coil. The increased current flow through the relay coil closes the relay 152. Then the relay 152 provides power from the power supply line 135 to the manual switch 146. Therefore, only when the rear door 103 is fully open, is the switch 146 powered.

Operation of the invention is as follows. In response to pressing the push button 113, the remote controller 112 sends a control signal to the receiver 114 in the vehicle 101. In response to the control signal, the receiver 114 outputs a DOOR_ACTUATE signal to the control module 104. In response to the DOOR_ACTUATE signal, the control module 104 reverses DC power applied to the motor 102 from the previous application of power The control module 104 signals the clutch 168 to engage or link the motor 102 and the gear drive 105. Thus operation of the remote controller 112 changes the door position. When the gear drive 105 opens the door 103, the door stops opening in response to the DOOR_OPEN signal. The door stops closing in response to a different signal.

The kneel pump system 124 and the ramp pump system 126 operate as follows. When opening the door 103, the limit switch 106 closes, causing the voltage at the output pin thereof to go to a grounded voltage or DOOR_OPEN signal (0 volts). The pulse stretcher 134 detects the voltage drop caused by the ground voltage and outputs a positive voltage pulse to the controller 122 for the predetermined time. In response to the pulse, the controller 122 operates the kneel pump system 124 and the ramp pump system 126. The hydraulic pump systems 124, 126 operate for predetermined time periods long enough to lower the rear end of the vehicle and deploy the ramp 128.

Storage of the ramp 128 and closing of the door 103 begins with a user actuating the push button 113. In response to actuation, the remote controller 112 sends a control signal to the receiver 114. As discussed above, in response to the signal from the receiver 114 and the door 103 being in an open position, the control module 104 powers the motor 102. The power line 116 carries the power signal to the motor 102. The input line 138 carries the same power signal as the RAMP_CLOSE signal to the controller 122. However, the clutch 168 remains disengaged. Thus closing of the door 103 does not start.

The control module 104 controls a sound generator 174 to output a warning signal for a predetermined time, approximately 2 to 3 seconds The warning signal begins approximately when the power signal is applied to the power line 116. The warning signal indicates that the door 103 is about to close. In response to the RAMP_CLOSE signal, the controller 122 immediately powers the kneel pump system 124 and the ramp pump system 126. Thus, the pump systems 124, 126 return the rear end of the vehicle to a driving position and the ramp 128 to the stowed position during sounding of the warning signal.

After the predetermined time, the warning signal stops. The control module 104 then controls the clutch 168. The clutch 168 engages the motor 102 and the gear drive 105, which closes the door 103. Because of the predetermined time delay in closing the door 103 due to the warning signal, there is adequate time to stow the ramp 128. The ramp 128 need not be completely stowed before beginning closing of the door 103. The ramp 128 merely needs to be advanced far enough ahead of the door 103 to avoid a collision therebetweeen.

Ignition switch 108 can be set to allow the door 103 to be opened or closed without the ramp extending and vehicle kneeling. Specifically when the switch 108 is in the on or ACC position, the status signal is input to the controller 122. In response to the input, a relay 149 eliminates the open signal on signal lines 130, 148. The input from the ignition switch 108 powers the normally closed relay 149 which opens the signal lines 130, 148 going to the controller 122. Thus, the relay 149 disables the signal lines and eliminates erroneous activation of the kneel pump system 124 or the ramp pump system 126. In response to this status signal, the controller 122 also separately closes a hydraulic valve integral with the ramp pump system 126. This further prevents operation thereof. Further, in response to the status signal, the controller 122 operates the kneel pump system 124 for a predetermined time, such as three seconds. This ensures that the vehicle 101 is in the raised drive position.

Thus, when the status signal is on, the remote controller 112 operates in the originally designed manner, before modification of the vehicle to include the ramp 128. Actuating the remote controller 112 only opens or closes the door 103. The ramp 128 does not move and the kneel pump system 124 merely ensures the vehicle rear end is in the raised driving position.

The manual switch 146 also controls the ramp 128 and the kneel pump system 124. The double-throw momentary manual switch 146 moves in two directions to close one of two sets of contacts. In one direction, the switch 146 signals the control system 120 to open the ramp 128 and lowers the vehicle rear end. In the other direction, the switch 146 signals the control system 120 to move the ramp 128 into the stowed position and raises the rear end of the vehicle 101. However, the manual switch 146 does not control the door 103 under any circumstances.

The switch 146 moves the ramp 128 only while the switch contacts remain closed. Thus, the ramp 128 or the rear end can be only partially deployed if the switch is not actuated for the proper amount of time. Therefore, the function of the switch 146 differs significantly from the remote controller 112 described above.

Moreover, when the controller 122 senses vehicle engine operation (status signal), the manual switch 146 does not function. In response to the status signal, the controller 122 disconnects power from the power supply line 135. No power is available to pass through the relay 152 to the switch 146. Thus, vehicle operation prevents manual operation of the kneel pump system 124 and the ramp pump system 126.

The manual switch 146 attempts to provide a signal to the controller 122 when the door 103 is closed. However, the door limit switch 106 must provide a ground signal (DOOR_OPEN signal) to enable sufficient current through the relay coil to close the relay 152. If the current through the relay coil is sufficient (door 103 open), the induced electromagnetic field closes the switch of the relay 152 and supplies power to the manual switch 146. Thus, so long as the door 103 remains closed, the switch 146 cannot signal the controller 122 and the ramp 128 cannot move.

The motor vehicle includes the powered door operating system 165 and remote controller 112. Thus no solenoid needs to be installed to modify the door 103 to open and shut the latch thereof. More importantly, the disclosed interface utilizes the remote controller 112 to control the ramp 128 and kneel pump system 124, instead of only the door 103. The integration of the control system 120 with the vehicle electronic system requires only the single remote controller 112. Thus two separate types of remote controllers are not required.

Further, the remote controller 112 enables a user to simply touch and release the single push button 113. Touch and release of the button 113 either deploys the ramp and lowers the rear end of the vehicle or stores the ramp 128 and raises the rear end. Thus, except when utilizing the manual switch 146, the user deploys and stores the ramp 128 without having to watch and control the specific amount of movement thereof. Therefore, the user need not carefully manipulate the remote controller 112 in the same manner as in the prior art.

The disclosed controller 122 is an analog circuit. Such circuits can also rely on elements, besides resistors and capacitors, to control the pump systems. Other circuit elements and arrangements, including digital circuitry, are also contemplated to provide the controller functions.

In FIG. 4, the pulse stretcher 134 is shown as a separate element from the controller 122. Other circuitry can provide the same function as the pulse stretcher 134. Such circuitry can be incorporated directly into the controller 122.

Vehicle circuitry or electronics, other than the power line 116 and the limit switch 106, can be connected to provide RAMP_CLOSE and DOOR_OPEN signals. For instance, other parts of the rear door control system 165 can be sensed. For example, the DOOR_OPEN signal can be provided by the combination of a signal line detecting power on line 118 for driving the door open, in combination with a timer providing delay until the door 103 is at least substantially open. After the time delay the ramp pump system 124 then deploys the ramp 128. However, interfacing signal receiving lines with the power line 116 and the limit switch 106 is preferred.

The kneel pump system 124 preferably operates simultaneously with the ramp pump system 126. However, the kneel pump system can also operate after the ramp pump system.

In some embodiments, the manual switch 146 can be provided as two separate switches.

In some embodiments, the warning signal can flash existing vehicle lights in addition to, or in place of, the warning sound from the sound generator 174.

The remote controller 112 preferably is a fob for a key chain. The remote controller 112 is shown including a plurality of push buttons to control a plurality of features. More or fewer push buttons can be utilized to control more or fewer vehicle features In any event, one push button must control both the door 103 and the ramp 128.

The disclosed powered rear door operating system 165 includes a bi-directional motor 102 and a clutch 168. However, other door operating arrangements are contemplated including different types of motors and coupling arrangements.

In other less preferred embodiments of the invention, the ramp may be located at a powered side door of the vehicle 101. The ramp then is controlled in response to actuation of the powered side door. Thus the apparatus would operate in a similar manner to the arrangement discussed above.

While kneel pump and ramp pump systems 124, 126 are preferred, other arrangements can be utilized. For example electric motors, screw drives, linear actuators, or other actuators and other powered linkage arrangements can provide the functions of the pump systems.

In summary, the control system 120 interfaces with a vehicle. As shown in FIG. 4, connecting four input signal lines integrates the control system 120 with a vehicle.

The described version of the powered ramp and rear door provides a user access primarily for mini-vans. Other vehicles, such as buses or sport utility vehicles having a rear door, can be modified to utilize this invention. It is the object of the appended claims to cover all variations and modifications that come within the sphere and scope of this invention.

What is claimed is:

1. A motor vehicle, said vehicle having:
a body, said body defining an opening and a floor within said body;
a door moveably attached to said body so to move from a closed position in which said door covers the body opening and an open position wherein the door is spaced away from the body opening;
a retractable ramp attached to said body, said retractable ramp having a stowed position in which said ramp is stored within said body and an extended position in which said ramp extends from said floor, through the body opening to ground level;
a door actuating assembly connected between said body and said door for moving said door between the closed position and the open position wherein, said door actuating assembly is configured to:
open or close said door upon receipt of a DOOR_ACTUATE signal; and
stop the opening movement of said door upon receipt of a DOOR_OPEN signal;
a ramp actuator for moving said ramp between the extended and stowed positions, said ramp actuator configured to move said ramp from the stowed position to the extended position upon receipt of the DOOR_OPEN signal; and
a door state sensor mounted to said body to monitor the open/closed state of the door, said door state sensor configured to generate the DOOR_OPEN signal to said door actuator and said ramp actuator when said door is open a select amount.

2. The motor vehicle of claim 1, further including a receiver for receiving a door control signal from a remote transmitter and wherein said receiver, upon receipt of the door control signal from the remote transmitter, generates the DOOR_ACTUATE signal and forwards the DOOR_ACTUATE signal to said door actuating assembly.

3. The motor vehicle of claim 1, wherein said door actuating assembly includes:
a linkage connected to said door for moving said door;
a bi-directional electric motor for actuating said linkage, said motor being responsive to a FORWARD signal so as to cause said motor to run in a direction that causes said linkage to open said door and being responsive a REVERSE signal so as to cause said motor to run in a direction that causes said linkage to close said door; and
a clutch located between said motor and said linkage for selectively connecting said motor to said linkage.

4. A motor vehicle, said vehicle having:
a body, said body defining an opening and a floor within said body;
a door moveably attached to said body so to move from a closed position in which said door covers the body opening and an open position wherein the door is spaced away from the body opening;
a retractable ramp attached to said body, said retractable ramp having a stowed position in which said ramp is stored within said body and an extended position in which said ramp extends from said floor, through the body opening to ground level;
a door actuator assembly connected between said body and said door for moving said door between the closed position and the open position in response to receipt of door close/open signals;
a receiver for receiving a signal from a remote transmitter wherein said receiver, upon receipt of the signal from the remote transmitter, generates a DOOR_ACTUATE signal;
a door controller configured to receive the DOOR_ACTUATE signal from the receiver that, in response to receipt of the DOOR_ACTUATE signal generates the door close/open signals and provides the door close/open signals to said door actuator assembly so as to cause the opening or closing of said door, wherein said door controller:
as part of a process of generating the door close/open signals to open said door, generates at least one door open control signal; and
as part of a process of generating the door close/open signals to close said door, generates at least one door close control signal;
a ramp actuator for moving said ramp between the extended and stowed positions, said ramp actuator being connected to said door controller and configured to move said ramp from the stowed position to the extended position upon receipt of a DOOR_OPEN signal and to move said ramp from the extended position to the stowed position in response to receipt of a RAMP_CLOSE signal; and
a door state sensor mounted to said body to monitor the open/closed state of the door, said door state sensor configured to generate the DOOR_OPEN signal to said door actuator and said ramp actuator when said door is open a select amount.

5. The motor vehicle of claim 4, wherein said door controller stops said door actuator assembly from opening the door in response to the DOOR_OPEN signal.

6. A motor vehicle comprising:
a body having a front end, a rear end, an interior floor and an opening;
a door movably attached to said body to move from a closed position covering the opening to an open position;
a single portable remote controller for transmitting a door signal;
a receiver for receiving the door signal from the portable remote controller and outputting a door control signal;
a door operating system comprising:
a) a control module for receiving the door control signal from the remote controller, said control module outputting one of a door opening signal and a door closing signal depending on receipt of the door control signal from the receiver and the present position of the door; and
b) an electric motor for moving the door between an open position in response to the door opening signal and a closed position in response to the door closing signal;
a folding ramp installed in the vehicle for deployment outwardly from the rear entrance so that a personal transportation device is capable of entering and exiting the vehicle on the ramp;
a ramp actuator for moving the folding ramp between a stored substantially upright position and a deployed position wherein an extended end of the ramp contacts the ground at a location outwardly from the rear end of the vehicle; and
a loading control system including a loading controller for receiving a DOOR_OPEN signal and a RAMP_CLOSE signal, the loading controller deploying the ramp in response to the DOOR_OPEN signal and stowing the ramp in response to the RAMP_CLOSE signal, so that the single remote controller controls the door and the folding ramp.

7. The motor vehicle of claim 6, wherein the door comprises a rear door and the ramp comprises a rearwardly folding ramp, the vehicle further including a kneel pump system for lowering and raising the rear end of the vehicle to a vehicle loading position adjacent ground level and a vehicle driving position with the rear end spaced away from the ground a sufficient distance for normal driving of the vehicle, the loading controller lowering the rear end of the vehicle in response to the DOOR_OPEN signal and raising the rear end in response to the RAMP_CLOSE signal, so that the single remote controller controls kneeling of the vehicle, opening and closing of the rear door and deploying and stowing of the ramp.

8. The vehicle of claim 6, wherein the door operating system includes a power line connecting power from the control module to the electric motor, the control module selectively applying a power signal on said power line for closing the door, the power signal providing the RAMP_CLOSE signal to the loading controller.

9. The vehicle of claim 8, wherein the door operating system includes a clutch for engaging the electric motor with a gear drive, the control module outputting a clutch engaging signal, a predetermined time after the power is applied to the power line, to move the door, the clutch engaging signal comprising the door closing signal.

10. The vehicle of claim 6, wherein the door operating system includes a door limit switch connected to an input of the control module, the door limit switch outputting a ground voltage signal thereto when the rear door is substantially open, the ground voltage signal comprising the DOOR_OPEN signal, and the loading control system includes a limit switch signal line the DOOR_OPEN signal to an input of a pulse stretcher, a falling edge of the voltage at the pulse stetcher input, caused by the ground voltage signal, triggering the pulse stretcher to send, for a predetermined time, a single positive pulse signal to the loading controller.

11. The vehicle of claim 6, wherein the loading control system includes a manual switch connected to the loading controller to actuate the ramp pump system independently of the portable remote controller, and without actuating or controlling the door.

12. The vehicle of claim 11, wherein the door operating system includes a door limit switch providing the DOOR_OPEN signal when the door is open a select amount, the manual switch receiving power through a relay triggered by the DOOR_OPEN signal, the relay preventing operation of the ramp pump system when the door is closed.

13. The vehicle of claim 6, wherein the single remote controller includes multiple push buttons, a first push button providing the door control signal, a second push button providing a door unlock signal and a third push button providing a door lock signal.

14. The vehicle of claim 6, wherein the loading controller controls the ramp actuator to store the ramp during a predetermined period of time before beginning closing of the door, the door operating system including a clutch for engaging the electric motor with a gear drive, the control module outputting a clutch engaging signal comprising the closing signal a predetermined time after a power signal is applied to a power line for the motor to close the door, the power signal comprising the RAMP_CLOSE signal.

15. The vehicle of claim 14, wherein said vehicle includes a speaker for providing a warning signal when the ramp is moving toward the stowed position, before beginning the closing of the door.

16. The vehicle of claim 6, wherein the loading control system includes a status input line connecting an input from a vehicle ignition switch to the loading controller, said status input line providing an operating status signal to the loading controller when the ignition switch is in the accessory or engine operating position, the loading controller preventing the ramp actuator from moving the ramp into the deployed position in response to the status signal.

17. The vehicle of claim 16, wherein the door comprises a rear door and the ramp comprises a rearwardly folding ramp, the vehicle including a kneel pump system for lowering and raising the rear end of the vehicle to a vehicle loading position adjacent ground level and a vehicle driving position with the rear end spaced away from the ground a sufficient distance for normal driving of the vehicle, the loading controller lowering the rear end of the vehicle in response to opening of the rear door and raising the rear end in response to closing of the door, so that the single remote controller controls kneeling of the vehicle, opening and closing of the rear door and deploying and stowing of the ramp, and
wherein the loading controller operates the kneel pump system for a predetermined period of time to ensure that the rear end of the vehicle is in the driving position when the status signal is initially sensed.

18. The vehicle of claim 16, wherein a single push button of the remote controller controls only opening and closing of the rear door when the loading controller receives the status signal.

19. The vehicle of claim 6, wherein the door comprises a rear door and the ramp comprises a rearwardly folding ramp.

20. The vehicle of claim 6, wherein the interior floor at the rear end of the vehicle is closer to ground level than the interior floor at the front end of the vehicle.
